(19) United States
(12) Patent Application Publication
(10) Pub. No.: US 2021/0170413 A1
(43) Pub. Date: Jun. 10, 2021

(54) VARIABLE ELECTRODE SIZE AREA ARRAYS ON THIN-FILM TRANSISTOR BASED DIGITAL MICROFLUIDIC DEVICES FOR FINE DROPLET MANIPULATION

(71) Applicant: E INK CORPORATION, Billerica, MA (US)

(72) Inventors: David ZHITOMIRSKY, Woburn, MA (US); Richard J. PAOLINI, Jr., Framingham, MA (US); Ian FRENCH, Hsinchu (TW); Timothy J. O'MALLEY, Westford, MA (US)

(21) Appl. No.: 17/110,896

(22) Filed: Dec. 3, 2020

Related U.S. Application Data
(60) Provisional application No. 62/943,295, filed on Dec. 4, 2019.

(51) Int. Cl. B01L 3/00

(52) U.S. Cl. CPC B01L 3/502784; B01L 2400/0415; B01L 2300/161

(57) ABSTRACT

A digital microfluidic device including a substrate and a controller. The substrate includes: a first high-resolution area and a second low-resolution area, and a hydrophobic layer. The first area includes a first plurality of electrodes having a first density D1, and a first set of thin-film-transistors coupled to the first plurality of electrodes. The second area includes a second plurality of electrodes having a second density D2, where D2<D1, and a second set of thin-film-transistors coupled to the second plurality of electrodes. The hydrophobic layer covers both the first and second pluralities of electrodes and the first and second sets of thin-film-transistors. The controller is operatively coupled to the first set and second set of thin-film-transistors and configured to provide a propulsion voltage to at least a portion of the first plurality of electrodes and at least a portion of the second plurality of electrodes.

### RELATED APPLICATIONS

This application claims priority to U.S. Provisional Patent Application No. 62/943,295, filed Dec. 4, 2019. All patents and publications disclosed herein are incorporated by reference in their entireties.

### BACKGROUND

Digital microfluidic devices use independent electrodes to propel, split, and join droplets in a confined environment, thereby providing a “lab-on-a-chip.” Digital microfluidic devices are alternatively referred to as electrowetting on dielectric, or “EWoD,” to further differentiate the method from competing microfluidic systems that rely on electrophoretic flow and/or micropumps. A 2012 review of the electrowetting technology was provided by Wheeler in “Digital Microfluidics,” Annu. Rev. Anal. Chem. 2012, 5:413-40, which is incorporated herein by reference in its entirety. The technique allows sample preparation, assays, and synthetic chemistry to be performed with tiny quantities of both samples and reagents. In recent years, controlled droplet manipulation in microfluidic cells using electrowetting has become commercially-viable; and there are now products available from large life science companies, such as Oxford Nanopore.

Most of the literature reports on EWoD involve so-called “direct drive” devices (a.k.a. “segmented” devices), whereby ten to several hundred electrodes are directly driven with a controller. While segmented devices are easy to fabricate, the number of electrodes is limited by space and driving constraints. Accordingly, it is not possible to perform massive parallel assays, reactions, etc. in direct drive devices. In comparison, “active matrix” devices (a.k.a. active matrix EWoD, a.k.a. AM-EWoD) devices can have many thousands, hundreds of thousands or even millions of addressable electrodes. In AM-EWoD devices electrodes are typically switched by thin-film transistors (TFTs) and droplet motion is programmable so that AM-EWoD arrays can be used as general purpose devices that allow great freedom for controlling multiple droplets and executing simultaneous analytical processes.

For active matrix devices, the drive signals are often output from a controller to gate and scan drivers that, in turn, provide the required current-voltage inputs to active the various TFT in the active matrix. However, controller-drivers capable of receiving, e.g., image data, and outputting the necessary current-voltage inputs to active the TFTs are commercially available. See e.g., a variety of controller-drivers available from UltraChip.

Having a high density of electrodes for all areas of the AM-EWoD device is not always necessary, especially if complex functions are not being carried out at all locations. Having high density electrodes at all locations requires faster (and more expensive) drivers and also increase the amount of data processing required. In some cases, it would be beneficial to have larger electrodes in some areas and smaller electrodes in other areas. Traditionally, groups of electrodes (i.e., “ganged” electrodes) have been used to represent larger structures than the base (smaller) electrode size. Nonetheless, combining smaller electrodes to represent larger ones increases the complexity of the system due to the increased number of drive lines and data requirements. U.S. Published Pat. Appl. No. 2016/0184823 proposes a solution to this problem. It discloses electrode sub-arrays of 8 different sizes, however, the architecture of the '823 publication is not suitable to create subarrays of different sized electrodes on the same TFT platform due to drive line and geometry requirements. In fact, in the '823 publication the miniature electrode arrangement must spansthe larger electrodes, to enable retention of the square symmetry and construction of identically sized droplets on both the miniature- and regular-sized subarrays.

### SUMMARY OF INVENTION

The present application addresses the shortcomings of the prior art by providing an alternate architecture for an AM-EWoD with variable electrode size areas. In one instance, the invention provides a digital microfluidic device having two areas of different electrode densities, i.e., a high-density (a.k.a. “high-res”) area, and a low density (a.k.a. “low-res”). Such a design will allow a user to perform droplet manipulation where needed. Overall, such a configuration simplifies the fabrication of a device while also simplifying the data handling associated with the sensing functions.

In one aspect, the digital microfluidic device includes a substrate and a controller. The substrate includes a first high-resolution area and a second low-resolution area, and a hydrophobic layer. The first area includes a first plurality of electrodes having a first density of D1 electrodes/unit area, and a first set of thin-film-transistors coupled to the first plurality of electrodes. The second area includes a second plurality of electrodes having a second density of D2 electrodes/unit area, where D2<D1, and a second set of thin-film-transistors coupled to the second plurality of electrodes. The unit area can be any standard of unit area, such as mm², cm², or in². The hydrophobic layer covers both the first and second pluralities of electrodes and the first and second sets of thin-film-transistors. The controller is operatively coupled to the first set and second set of thin-film-transistors and configured to provide a propulsion voltage to at least a portion of the first plurality of electrodes and at least a portion of the second plurality of electrodes. In one embodiment, a ratio D1:D2 is equal to about 2ⁿ, n being a natural number. For example, the ratio D1:D2 may be equal to about 2, 4, 8, or 16. In another embodiment, the ratio D1:D2 is equal to about 3, 5, 6, 7, 9 or other integer numbers not equal to 2ⁿ. In a further embodiment, the electrodes of the first plurality may be from about 25 μm to about 200 μm in size. In an additional embodiment, the electrodes of the second plurality may be from about 100 μm to about 800 μm in size. The first area may be smaller than the second area, and the first plurality of electrodes may be arranged in a square or rectangular subarray. The hydrophobic layer may be made of an insulating material, or a dielectric layer may be interposed between the hydrophobic layer and the first and second pluralities of electrodes.

In one embodiment, the device further includes one or more fluid reservoirs operably connected to the first area through reservoir outlets. The device may include more than one high-resolution areas, each high-resolution area being connected to its set of thin-film-transistors and one or more reservoirs. In representative embodiments, the microfluidic device further includes a singular top electrode, a top hydrophobic layer covering the singular top electrode and a spacer separating the hydrophobic layer and the top hydrophobic layer and creating a microfluidic cell gap between the hydrophobic layer and the top hydrophobic layer. A top dielectric layer may be interposed between the top hydrophobic layer and the singular top electrode. In one embodiment, he cell gap is from about 20 μm to 500 μm. In one embodiment, the top electrode includes at least one light-transmissive region, for example 10 mm² in area, to enable visual or spectrophotometric monitoring of fluid droplets inside the device.

In a second aspect, a digital microfluidic device, including (i) a substrate comprising a first high-resolution area comprising a first plurality of electrodes, each of the first plurality of electrodes being in electrical communication with a first plurality of source lines, the first plurality of source lines having a first source line density of D1 source lines/unit area, as well as a first set of thin-film-transistors coupled to the first plurality of electrodes and the first plurality of source lines. The substrate additionally includes a second low-resolution area comprising a second plurality of electrodes, each of the second plurality of electrodes being in electrical communication with a second plurality of source lines, the second plurality of source lines having a second source line density of D2 source lines/unit area, wherein D1>D2, and a second set of thin-film-transistors coupled to the second plurality of electrodes and the second plurality of source lines. The substrate includes a hydrophobic layer covering both the first and second pluralities of electrodes as well as the first and second sets of thin-film-transistors. The digital microfluidic device also includes (ii) a source driver operatively coupled to the first plurality of source lines and the second plurality of source lines, and configured to provide a source voltage to at least a portion of the first plurality of electrodes and at least a portion of the second plurality of electrodes. In the digital microfluidic device, at least a portion of the second plurality of source lines are connected to one of the first plurality of source lines.

In a third aspect, the present application provides a method for assaying an analyte in a sample with the digital microfluidic device of the above first aspect. The method includes: depositing a sample droplet on the surface of the high-resolution area of the device; subjecting the droplet to one or more processing steps selected from the group consisting of diluting, mixing, sizing, and combinations thereof, to form a fluid containing an assay product; transferring a droplet of the fluid containing the assay product to the surface of the low-resolution area of the device; detecting the assay product; and optionally measuring the concentration of the assay product. In one embodiment, the analyte is a diagnostic biomarker that may be detected and quantified by binding to an antibody matching the biomarker, for example in an enzyme-linked, immunosorbent assay.

### BRIEF DESCRIPTION OF DRAWINGS

FIG. 1 is a schematic diagram of an exemplary variable-size-electrode array.

FIG. 2 depicts the movement of an aqueous-phase droplet between adjacent electrodes by providing differing charge states on adjacent electrodes.

FIG. 3 shows a TFT architecture for a plurality of propulsion electrodes of an EWoD device of the invention.

FIG. 4 is a schematic diagram of a portion of the first substrate, including a propulsion electrode, a thin film transistor, a storage capacitor, a dielectric layer, and a hydrophobic layer.

FIG. 5 illustrates that certain driver lines can be terminated to reduce capacitive coupling between drive lines and larger pixel electrodes.

FIG. 6 is a schematic diagram of another exemplary variable size electrode array.

FIG. 7 is a schematic diagram of an AM-EWoD device with a variable size electrode array and fluid reservoirs.

### DETAILED DESCRIPTION

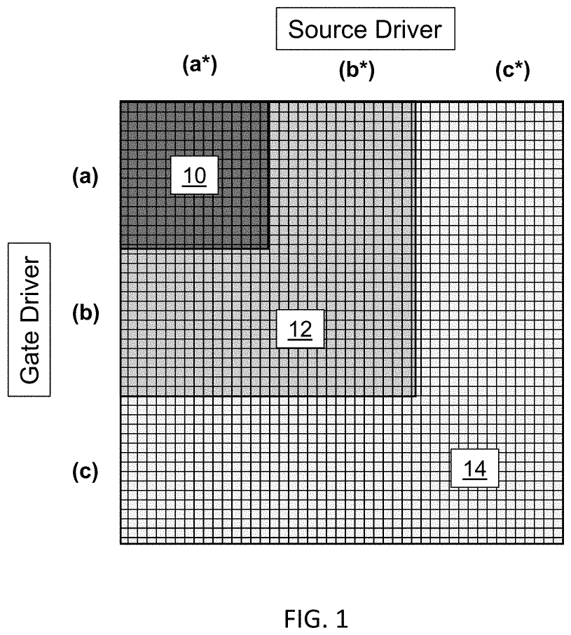

As indicated above, the present invention provides an active matrix electrowetting on dielectric (AM-EWoD) device including an array of different sized electrodes on a thin-film transistor (TFT) platform, i.e., as shown in FIG. 1. This configuration may be easily manufactured by modifying the mask patterns customarily used in traditional TFT manufacturing processes, i.e., wherein typically (nearly) all of the pixel electrodes are identical in size and the density of electrodes and drive lines is uniform across the TFT platform.

Variable electrode sizes make better use of the surface available on the AM-EWoD device, and advanced functionality can be added in without increasing the overall complexity. In one example embodiment, the array includes one or more high-density, high resolution areas where subarrays of miniature electrodes are located. This miniature subarray implementation allows for improved droplet sizing (e.g., splitting) that is fully compatible with metering systems and is designed to result in the best possible size control. Moreover, miniature electrode areas allow for greater concentration ranges and will reduce the number of serial dilution steeps that are needed in order to reach desired concentrations.

The miniature electrode, high-resolution areas can include locations where a “regular” size droplet can be created/assembled and fed into areas containing subarrays of regular- or larger-sized electrodes. The areas are compatible with TFT manufacturing and can easily span the main digital microfluidic (DMF) array of an EWoD device. The high-resolution areas will increase the number of diffusion interfaces and facilitate more complete mixing. This technique is then fully compatible with standard mixing techniques.

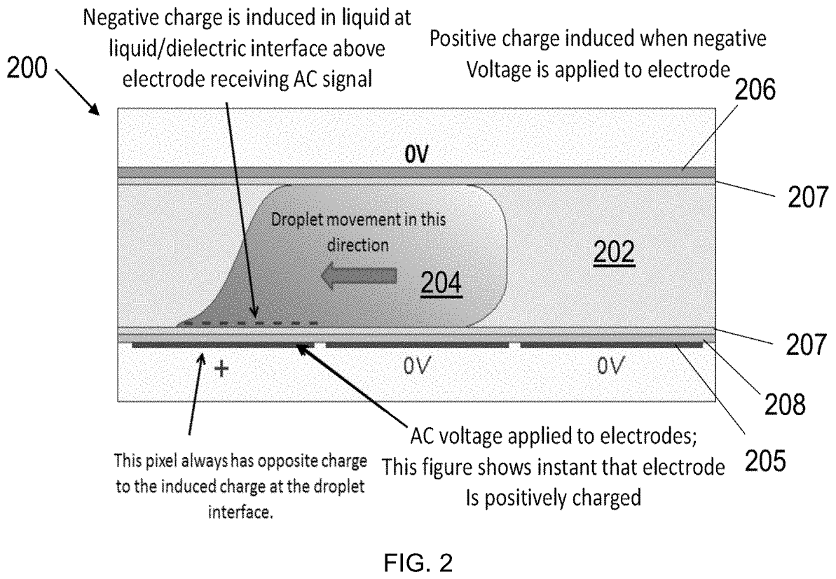

A typical AM-EWoD device consists of a thin film transistor backplane with an exposed array of regularly shaped electrodes that may be arranged as pixels. The pixels may be controllable as an active matrix, thereby allowing for the manipulation of sample droplets. The array is usually coated with a dielectric material, followed by a coating of hydrophobic material. The fundamental operation of a typical EWoD device is illustrated in the sectional image of FIG. 2. The EWoD 200 includes a cell filled with an oil layer (or other hydrophobic fluid) 202 and at least one aqueous droplet 204. The cell gap is typically in the range 50 to 200 μm, but the gap can be larger or smaller. In a basic configuration, as shown in FIG. 2, an array of propulsion electrodes 205 are disposed on one substrate and a singular top electrode 206 is disposed on the opposing surface. The cell additionally includes hydrophobic coatings 207 on the surfaces contacting the oil layer 202, as well as a dielectric layer 208 between the array of propulsion electrodes 205 and the hydrophobic coating 207. (The upper substrate may also include a dielectric layer, but it is not shown in FIG. 2). The hydrophobic coating 207 prevents the droplet from wetting the surface. When no voltage differential is applied between an electrode and the top plate, the droplet will maintain a spheroidal shape to minimize contact with the hydrophobic surfaces (oil and hydrophobic layer). Because the droplets do not wet the surface, they are less likely to contaminate the surface or interact with other droplets except when that behavior is desired. Accordingly, individual aqueous droplets can be manipulated about the active matrix, and mixed, split, combined, as known in the field.

While it is possible to have a single layer for both the dielectric and hydrophobic functions, such layers typically require thick inorganic layers (to prevent pinholes) with resulting low dielectric constants, thereby requiring more than 100V for droplet movement. To achieve low voltage actuation, it is usually better to have a thin inorganic layer for high capacitance and to be pinhole free, topped by a thin organic hydrophobic layer. With this combination it is possible to have electrowetting operation with voltages in the range+/−10 to +/−50V, which is in the range that can be supplied by conventional TFT arrays.

When a voltage differential is applied between adjacent electrodes, the voltage on one electrode attracts opposite charges in the droplet at the dielectric-to-droplet interface, and the droplet moves toward this electrode, as illustrated in FIG. 2. The voltages needed for acceptable droplet propulsion depend on the properties of the dielectric and hydrophobic layers. AC driving is used to reduce degradation of the droplets, dielectrics, and electrodes by various electrochemistries. Operational frequencies for EWoD can be in the range 100 Hz to 1 MHz, but lower frequencies of 1 kHz or lower are preferred for use with TFTs that have limited speed of operation.

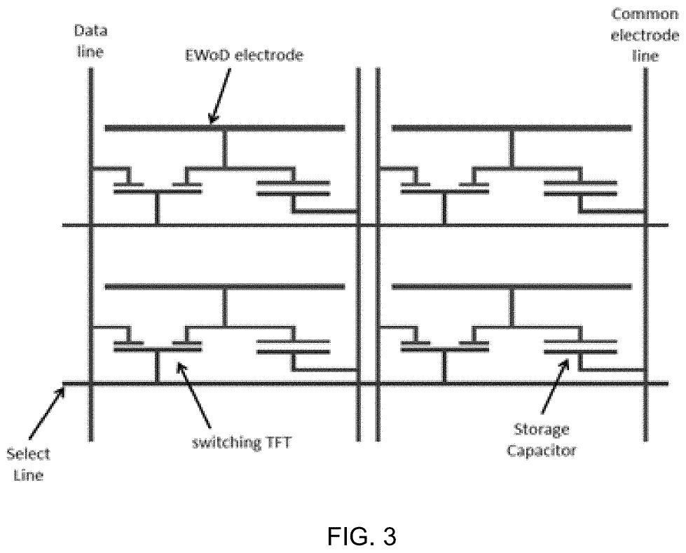

As shown in FIG. 2, the top electrode 206 is a single conducting layer normally set to zero volts or a common voltage value (VCOM) to take into account offset voltages on the propulsion electrodes 205 due to capacitive kickback from the TFTs that are used to switch the voltage on the electrodes (see FIG. 3). The use of “top” and “bottom” is merely a convention as the locations of the two electrodes can be switched, and the device can be oriented in a variety of ways, for example, the top and bottom electrode can be roughly parallel while the overall device is oriented so that the substrates are normal to a work surface. In one embodiment, the top electrode includes a light-transmissive region, for example 10 mm² in area, to enable visual or spectrophotometric monitoring of fluid droplets inside the device (not shown). The top electrode can also have a square wave applied to increase the voltage across the liquid. Such an arrangement allows lower propulsion voltages to be used for the TFT connected propulsion electrodes 205 because the top plate voltage 206 is additional to the voltage supplied by the TFT.

As illustrated in FIG. 3, an active matrix of propulsion electrodes can be arranged to be driven with data (source) lines and gate (select) lines much like an active matrix in a liquid crystal display. The gate (select) lines are scanned for line-at-a time addressing, while the data (source) lines carry the voltage to be transferred to propulsion electrodes for electrowetting operation. If no movement is needed, or if a droplet is meant to move away from a propulsion electrode, then 0V will be applied to that (non-target) propulsion electrode. If a droplet is meant to move toward a propulsion electrode, an AC voltage will be applied to that (target) propulsion electrode.

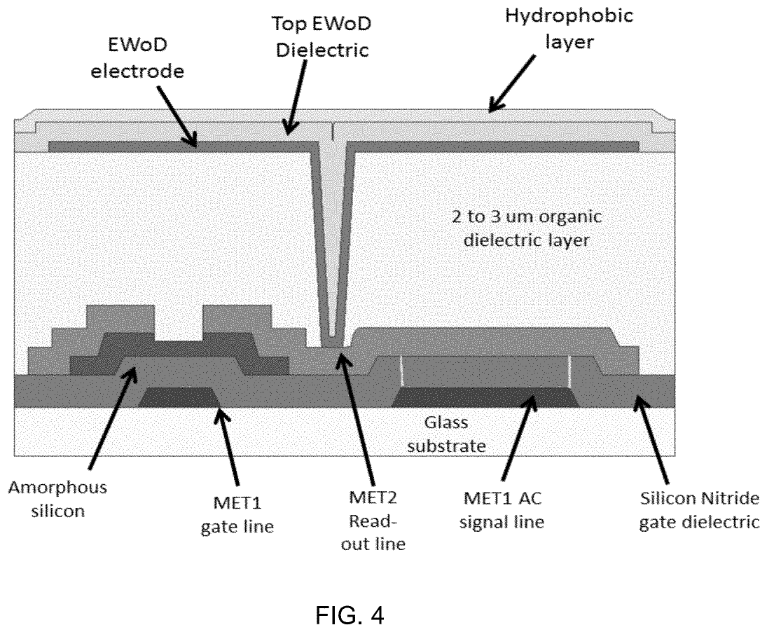

The architecture of an exemplary, TFT-switched, propulsion electrode is shown in FIG. 4. The dielectric 408 should be thin enough and have a dielectric constant compatible with low voltage AC driving, such as available from conventional image controllers for LCD displays. For example, the dielectric layer may comprise a layer of approximately 20-40 nm SiO2 topped over-coated with 200-400 nm plasma-deposited silicon nitride. Alternatively, the dielectric may comprise atomic-layer-deposited Al₂O₃ between 5 and 500 nm thick, preferably between 150 and 350 nm thick. The TFT is constructed by creating alternating layers of differently-doped Si structures along with various electrode lines, with methods know to those of skill in the art.

The hydrophobic layer 407 can be constructed from one or a blend of fluoropolymers, such as PTFE (polytetrafluoroethylene), FEP (fluorinated ethylene propylene), PVF (polyvinylfluoride), PVDF (polyvinylidene fluoride), PCTFE (polychlorotrifluoroethylene), PFA (perfluoroalkoxy polymer), FEP (fluorinated ethylene-propylene), ETFE (polyethylenetetrafluoroethylene), and ECTFE (polyethylenechlorotrifluoroethylene). Commercially available fluoropolymers Teflon® AF (Sigma-Aldrich, Milwaukee, Wis.) and FluoroPel′ coatings from Cytonix (Beltsville, Md.), which can be spin coated over the dielectric layer 408. An advantage of fluoropolymer films is that they can be highly inert and can remain hydrophobic even after exposure to oxidizing treatments such as corona treatment and plasma oxidation. Coatings having higher contact angles may be fabricated from one or more superhydrophobic materials. Contact angles on superhydrophobic materials typically exceed 150°, meaning that only a small percentage of a droplet base is in contact with the surface. This imparts an almost spherical shape to the water droplet. Certain fluorinated silanes, perfluoroalkyls, perfluoropolyethers and RF plasma-formed superhydrophobic materials have found use as coating layers in electrowetting applications and render it relatively easier to slide along the surface. Some types of composite materials are characterized by chemically heterogeneous surfaces where one component provides roughness and the other provides low surface energy so as to produce a coating with superhydrophobic characteristics. Biomimetic superhydrophobic coatings rely on a delicate micro or nano structure for their repellence, but care should be taken as such structures tend to be easily damaged by abrasion or cleaning.

Variable Electrode Size Areas

In one aspect of the invention, the general layout of the thin film transistor array is modified by partitioning into two or more areas (See FIG. 1). The electrodes of one area are of a size differing from that of at least another area, thereby creating two or more areas having different electrode matrix densities and thus different pixel resolution. Unless otherwise specified, the term “size” of an electrode as intended herein is defined to mean the length of the longest straight segment connecting two points on the outer perimeter of the electrode and lying entirely within the surface of the electrode. This novel architecture enables advanced functionality and high-resolution operations in specific regions of the array while adding minimum complexity to the driver and data requirements by lowering the electrode resolution in low-resolution areas where high functionality is not needed. This approach minimizes manufacturing difficulties and contains costs. As demonstrated below, an electrode matrix configuration based on variable electrode size areas reduces the number of required source/gate lines and the data density of the array.

Gate Source Line Density

Unless otherwise specified, the term “line density” refers to the number of source or gate driver lines per surface area unit of a subarray. If along the source driver of the array there are N areas containing subarrays of line density a or b, where the ratio a:b=Q, then, assuming there are a number X of areas of density a, it can be shown that the ratio Rₗᵢₙₑₛ between the source/gate lines required when N is all a (Nₐ) to those required when N is comprised of a and b (N_{ab}) is as set out in equation (1):

$${R}_{l i n e s} = \frac{{N}_{a}}{{N}_{a b}} = \frac{N Q}{X ( Q - 1 ) + N} \qquad ( 1 )$$

For large N, Rₗᵢₙₑₛ approaches Q. Thus, there is immediate benefit to reducing the number of required source and gate lines. Likewise, the array may include several areas containing subarrays of decreasing line density, for example area X1 of density a, area X2 of density b, and area X3 of density c, and so on, where a>b>c>d> . . . , then it can be shown that Runes is as set out in equation (2):

$${R}_{lines} = \frac{{N}_{a}}{{N}_{abcd …}} = \frac{N}{X 1 + \frac{1}{Q 1} X 2 + \frac{1}{Q 2} X 3 …} \qquad ( 2 )$$

Since Σ₁^{zones} X=N, then R as per equation (2) is necessarily greater than 1, thereby proving that Qₙ is greater than 1, which it is, given that X1, X2, X3 . . . are of lower density than X1.

### Data Density

Furthermore, it can be shown that ratio R_{data} comparing the data density in the instance when all the N areas are of line density a (Nₐ) to that when N is comprised of a and b (N_{ab}) is as set out in equation (3), X and Y being the number of areas having density a for the source and the gate lines, respectively:

$${R}_{data} = \frac{{N}_{a}}{{N}_{a b}} = \frac{{N}^{2} {Q}^{2}}{XY ( {Q}^{2} - 1 ) + {N}^{2}} \qquad ( 3 )$$

It is to be noted that the product XY≤N² because X and Y can be at most equal to N, that is, the number of areas along either the driver or source side that can be of electrode density a. For diminishing X and Y, the ratio approaches Q². For large X, the ratio approaches the value of 1. In sum, the benefits deriving from the variable electrode size areas include a source/gate driver complexity approaching the value of Q and data complexity nearing the value of Q².

### Exemplary Architectures

### Example 1

The diagram of FIG. 1 illustrates the structure of an exemplary variable size electrode array. The array is partitioned into three areas 10, 12, and 14, where the subarray of each area is defined by its respective drive line density a, b, or c. While the areas of FIG. 1 have the same row and column line density, this is not a requirement. For instance, area 10 may be characterized by row line density a, but also by a column line density a*, which may be greater or lesser than a, depending on the requirements of the application at hand. In one exemplary implementation, lower density areas branch away from a high-density area. In addition, if desired, the gate and source lines may be terminated to adjust for a desired density as one ventures deeper into the array to avoid extra capacitance in the lower density areas arising from the high-density lines. The advantage to this design feature is the ability to carry out high-resolution operations on the array at reduced gate and/or source line requirement and with less data processing.

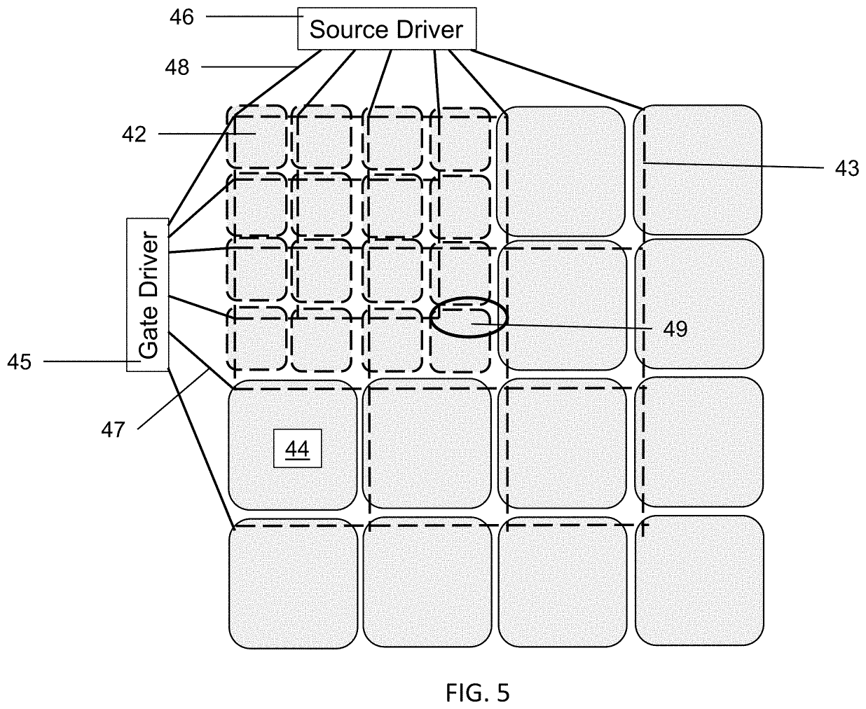

An exemplary routing for source and driver lines is shown in FIG. 5. In a preferred embodiment, the areas of higher density drive electrodes 42 are distributed closer to the source and gate drivers, and the areas of lower density drive electrodes 44 fan out from the higher density areas. Gate drive lines 47 run from gate driver 45 and source drive lines 48 run from source driver 46. (Notably, the thin-film-transistors controlling each drive electrode are not shown in FIG. 5. In FIG. 5, a TFT would be located in the upper left-hand corner of each drive electrode.) In the embodiment of FIG. 5, multiple gate driver lines 47 and multiple source driver lines 48 are terminated early, as highlighted by oval 49, in FIG. 5. That is, certain driver lines do not extend across the entire array, because there are no further TFTs to control past the driver line terminus. In embodiments of the invention, this architecture allows a single gate driver 45 and a single source driver 26 to drive the entire array despite the varying density of drive electrodes (42, 44). While a signal may be created to activate a pixel, there will not simultaneously be a source and gate driver signal at TFT to energize an electrode in the lower density areas. Furthermore, by terminating the gate driver lines 47 and source driver lines 48 early, there is less capacitive coupling between the lower density electrodes 44 and the gate driver lines 47 and source driver lines 48, which would otherwise run beneath the lower density electrodes 44. In other cases, a single driver line might span only electrodes of one size and density. As shown in FIG. 5, arranging the higher density drive electrodes 42 starting in one corner results in a natural pattern of a first square array of higher density drive electrodes 42 (4×4 in FIG. 5) leading to evenly spaced lower density drive electrodes 44. In this arrangement, the even numbers of the gate driver lines 47 and source driver lines 48 are terminated early.

### Example 2

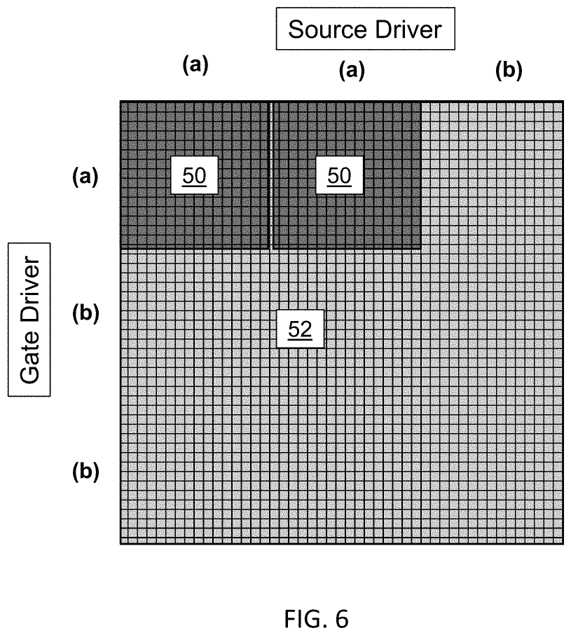

Illustrated in FIG. 6 is the structure of another exemplary variable size array. Area 50 is of line density (row and column) a, and area 32 is of line density b. Line density a is greater than b. As such, if D1 is defined as the electrode density of area 50, as expressed for instance in terms of number of electrodes per 100 mm², and D2 is defined as the electrode density of area 52, then the ratio D1:D2 exceeds the value of 1. In representative embodiments, the ratio D1:D2 is equal to about 2′, n being a natural number, so as to maintain a square electrode format. For example, the ratio D1:D2 may be equal to about 2, 4, 8, or 16 to suit the application at hand. The size of individual electrodes in AM-EWoD devices usually falls in a range from about 50 μm to about 600 μm. Hence, if the electrodes of area 52 are 600 μm in size, those of area 50 may be 300, 150, or 75 μm depending on whether the desired ratio D1:D2 is 2, 4, or 8.

Embodiments where the D1:D2 ratio is equal to 3, 5, 6, 7, 9 or other integers not equal to 2ⁿ are also contemplated. In one instance, the size of the area 50 electrodes may be in a range from about 25 μm to about 200 μm, while those of area 52 may fall in the range between about 100 μm to about 800 μm. Accordingly, if the electrodes of area 50 are 50 μm in size, the ratio D1:D2 may be 2, 3, 4, 5, 6, 7, etc. depending on the size chosen for the electrodes of area 52.

In one embodiment, area 50 is placed closer to upper and left edges of the array, and from there the density decreases moving away from the edges. This placement enables reducing the line density of the subarrays when crossing from area 50 into area 52. Alternatively, the line density may be kept constant along each row or column, but connections are not made to the pixels themselves.

### Example 3

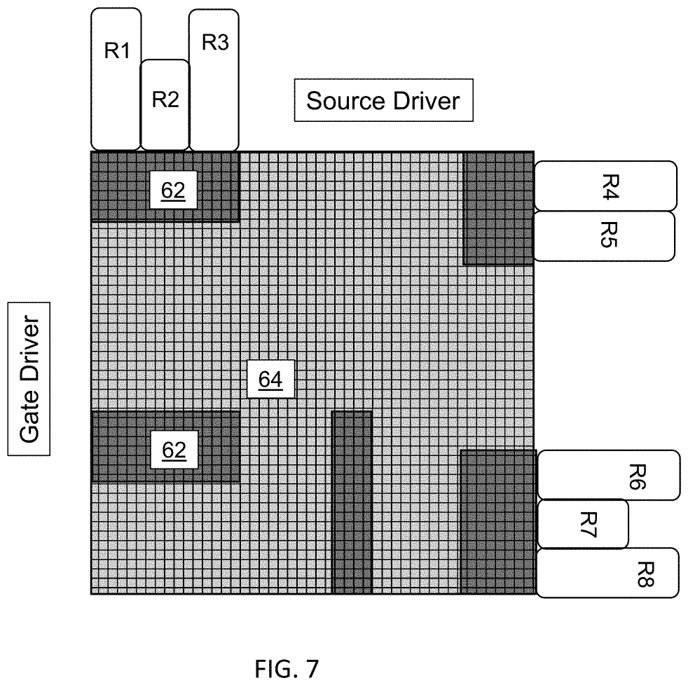

The schematic drawing of FIG. 7 illustrates an example AM-EWoD device 60. Reservoirs R1 contain a first type of fluid, reservoirs R2 a second type of fluid, and reservoir R3 a third type of fluid. The TFT array of the device includes high electrode density areas 62 in the proximity of the reservoir inlets, so that sample droplets can be taken from a reservoir and deposited on the surface of a high electrode density area. The high electrode density of the subarrays of areas 62 enables carrying out assay steps such as diluting, mixing, and sizing (splitting) of sample droplets with high accuracy. In one example embodiment, a sample droplet to be assayed for the presence and optionally the concentration of an analyte to is diluted by combination with one or more droplets of a solvent, and the dilution step may be repeated until a desired analyte concentration range is attained. Then, a droplet of the diluted sample is mixed with droplet(s) of one or more reactants that form a detectable, quantifiable assay product with the analyte.

Thereafter, the sample droplets may be transferred to low-resolution zone 63 for detecting and measuring the concentration of the assay product. Example detection and measuring techniques include spectrophotometry in the visible, UV, and IR ranges, time-resolved spectroscopy, fluorescence spectroscopy, Raman spectroscopy, phosphorescence spectroscopy, and potentiodynamic electrochemical measurements such as cyclic voltammetry (CV). In instances where the analyte is a diagnostic biomarker, for example a protein associated with a given disease or disorder, the sample droplet may be mixed with a droplet of a solution containing an antibody directed against the protein to be measured. In an enzyme-linked immunosorbent assay (ELISA), the antibody is linked to an enzyme, and another droplet, this time of a substance containing the enzyme's substrate, is added. The subsequent reaction produces a detectable signal, most commonly a color change that may be detected and measured at one or more pixels in the low-resolution area.

If the average diameter of sample droplets measures about n high-resolution pixels in length, then a high density area should preferably include at least 2n pixels in order to provide sufficient space for droplet manipulation. By limiting the share of source and/or drive lines dedicated to generating high-resolution areas to about 25% to 50% of the total, gate and/or source driver complexity is reduced, as is data complexity. This in turn implies a gate/source requirement reduction of about 30% to 60% and a 2.3- to 3.4-fold reduction in the amount of data.

From the foregoing, it will be seen that the present invention can provide for a device having high complexity only in areas where it is warranted, thereby keeping overall complexity at a minimum and lowering manufacturing and operating costs alike. It will be apparent to those skilled in the art that numerous changes and modifications can be made in the specific embodiments of the invention described above without departing from the scope of the invention. Accordingly, the whole of the foregoing description is to be interpreted in an illustrative and not in a limitative sense.

1. A digital microfluidic device, comprising:
(i) a substrate comprising:
a first high-resolution area comprising:
a first plurality of electrodes having a first density D1 electrodes/unit area, and
a first set of thin-film-transistors coupled to the first plurality of electrodes;
a second low-resolution area comprising:
a second plurality of electrodes having a second density D2 electrodes/unit area, where D2<D1, and
a second set of thin-film-transistors coupled to the second plurality of electrodes; and
a hydrophobic layer covering both the first and second pluralities of electrodes as well as the first and second sets of thin-film-transistors; and
(ii) a controller operatively coupled to the first set and second set of thin-film-transistors and configured to provide a propulsion voltage to at least a portion of the first plurality of electrodes and at least a portion of the second plurality of electrodes.

2. The digital microfluidic device of claim 1, wherein a ratio D1:D2 is equal to 2″, n being a natural number.

3. The digital microfluidic device of claim 2, wherein the ratio D1:D2 is equal to 2, 4, 8, or 16.

4. The digital microfluidic device of claim 1, wherein the ratio D1:D2 is equal to 3, 5, 6, 7, or 9.

5. The digital microfluidic device of claim 1, wherein the electrodes of the first plurality are from about 25 μm to about 200 μm in size.

6. The digital microfluidic device of claim 1, wherein the electrodes of the second plurality are from about 100 μm to about 800 μm in size.

7. The digital microfluidic device of claim 1, wherein the first high-resolution area is smaller than the second low-resolution area.

8. The digital microfluidic device of claim 1, wherein the first plurality of electrodes are arranged in a square or rectangular subarray.

9. The digital microfluidic device of claim 1, further comprising a dielectric layer interposed between the hydrophobic layer and the first and second pluralities of electrodes.

10. The digital microfluidic device of claim 1, further comprising a fluid reservoir operably connected to the first high-resolution area through a reservoir outlet.

11. The digital microfluidic device of claim 1, further comprising:
a second high-resolution area comprising a third plurality of electrodes of the first density D1 electrodes/unit area,
a third set of thin-film-transistors coupled to the third plurality of electrodes, and
a second reservoir operably connected to the second high-resolution area.

12. The digital microfluidic device of claim 1, further comprising a singular top electrode, a top hydrophobic layer covering the singular top electrode and a spacer separating the hydrophobic layer and the top hydrophobic layer and creating a microfluidic cell gap between the hydrophobic layer and the top hydrophobic layer.

13. The digital microfluidic device of claim 12, further comprising a top dielectric layer interposed between the top hydrophobic layer and the singular top electrode.

14. The digital microfluidic device of claim 12, wherein the cell gap is from about 20 μm to 500 μm.

15. The digital microfluidic device of claim 12, wherein the top electrode includes at least one light-transmissive region.

16. The digital microfluidic device of claim 15, wherein the light-transmissive region is at least 10 mm² in area.

17. A digital microfluidic device, comprising:
(i) a substrate comprising:
a first high-resolution area comprising:
a first plurality of electrodes, each of the first plurality of electrodes being in electrical communication with a first plurality of source lines, the first plurality of source lines having a first source line density of D1 source lines/unit area, and
a first set of thin-film-transistors coupled to the first plurality of electrodes and the first plurality of source lines;
a second low-resolution area comprising:
a second plurality of electrodes, each of the second plurality of electrodes being in electrical communication with a second plurality of source lines, the second plurality of source lines having a second source line density of D2 source lines/unit area, wherein D1>D2, and
a second set of thin-film-transistors coupled to the second plurality of electrodes and the second plurality of source lines; and
a hydrophobic layer covering both the first and second pluralities of electrodes as well as the first and second sets of thin-film-transistors; and
(ii) a source driver operatively coupled to the first plurality of source lines and the second plurality of source lines, and configured to provide a source voltage to at least a portion of the first plurality of electrodes and at least a portion of the second plurality of electrodes,
wherein at least a portion of the second plurality of source lines are connected to one of the first plurality of source lines.

18. A method for assaying an analyte in a sample with the digital microfluidic device of claim 1, the method comprising:
depositing a sample droplet on the surface of the first high-resolution area of the device;
subjecting the droplet to one or more processing steps selected from the group consisting of diluting, mixing, sizing, and combinations thereof, to form an assay product;
transferring a droplet of the product to the surface of the low-resolution area of the device;
detecting the assay product; and
optionally measuring a concentration of the assay product.

19. The method for assaying an analyte of claim 18, wherein the analyte is a diagnostic biomarker.

20. The method for assaying an analyte of claim 19, wherein the mixing is with a droplet of a solution containing an antibody matching the diagnostic biomarker.
